(19) United States
(12) Patent Application Publication
(10) Pub. No.: US 2026/0180382 A1
(43) Pub. Date: Jun. 25, 2026

(54) MOTOR AND A VEHICLE INCLUDING THE SAME

(71) Applicants: HYUNDAI MOTOR COMPANY, Seoul (KR); KIA CORPORATION, Seoul (KR)

(72) Inventors: Il Suk Yang, Hwaseong-si (KR); Young Jin Shin, Hwaseong-si (KR); Jae Min Yu, Hwaseong-si (KR); Hyeok Jun Jo, Hwaseong-si (KR); Seok Hoon Jo, Hwaseong-si (KR); Jae Chang Bae, Hwaseong-si (KR); Dong Yeon Han, Hwaseong-si (KR); Min Bok Cho, Hwaseong-si (KR)

(73) Assignees: HYUNDAI MOTOR COMPANY, Seoul (KR); KIA CORPORATION, Seoul (KR)

(21) Appl. No.: 19/220,889

(22) Filed: May 28, 2025

(30) Foreign Application Priority Data
Dec. 23, 2024 (KR) 10-2024-0194002

(51) Int. Cl. H02K 1/20; H02K 1/16; H02K 5/20

(52) U.S. Cl. CPC H02K 1/20; H02K 1/16; H02K 5/20

(57) ABSTRACT

A motor includes a stator core, and a rotor disposed inside the stator core. The stator core includes a first flow path disposed along an outer peripheral surface of the stator core, a second flow path intersecting the first flow path, a third flow path communicating with the second flow path and disposed in a radial direction of the stator core, and a hole formed in a front surface of the stator core. The hole communicates with the third flow path.

### CROSS-REFERENCE TO RELATED APPLICATION(S)

This application claims benefit of and priority to Korean Patent Application No. 10-2024-0194002, filed on Dec. 23, 2024 in the Korean Intellectual Property Office, the disclosure of which is incorporated herein by reference in its entirety.

### BACKGROUND

### 1. Field

The present disclosure relates to a motor for a vehicle and a vehicle including the same.

### 2. Description of Related Art

Motors are used as essential power sources in various industrial and vehicular applications, and play a role in converting electrical energy into mechanical energy. In detail, in high-efficiency vehicles such as electric vehicles, the efficiency and stability of the motor may directly affect vehicle performance. Heat generated during operation of the motor may cause problems such as performance degradation, damage due to overheating, or shortened lifespan, an effective cooling system is required.

Traditionally, air cooling or cooling oil has been used for motor cooling. Although the air cooling method is structurally simple, it has limitations in sufficiently controlling the heat generated by high-power motors. On the other hand, oil cooling allows for efficient heat control, but if the flow path of the cooling fluid is not properly designed, the cooling efficiency may decrease or overheating may occur in certain areas.

In detail, the stator core and coil are areas in which heat generation in the motor is concentrated, and if heat management is not properly performed, motor performance may decrease or the coil may be damaged. In existing technologies, methods that provide a limited cooling path to the outer peripheral surface or some parts of the stator core are mainly used, but this method has limitations in performing overall heat management of the coil and core.

The matters described in this Background section are only intended to enhance understanding of the background of the present disclosure. Therefore, the Background section may contain information that does not form prior art that is already known to those having ordinary skill in the art to which the present disclosure pertains.

### SUMMARY

An aspect of the present disclosure is to provide a motor having a cooling path structure designed to allow cooling fluid to efficiently flow to major parts of a coil and a stator core. In detail, by allowing a cooling fluid to flow along a plurality of cooling paths to an outer peripheral surface of the stator core, in the radial direction, and to a coil end portion, overall heat management of the motor may be effectively achieved.

According to an aspect of the present disclosure, a motor includes a stator core; and a rotor disposed inside the stator core. The stator core includes a first flow path disposed along an outer peripheral surface of the stator core; at least one second flow path intersecting the first flow path; at least one third flow path communicating with the second flow path and disposed in a radial direction of the stator core; and at least one hole disposed in a front surface of the stator core. The hole communicates with the third flow path.

The least one hole may be provided as a plurality of holes, and the plurality of holes may include a first hole; and a second hole spaced apart from the first hole radially outwardly of the stator core.

The stator core may include at least one teeth portion formed on an inner surface of the stator core and a coil is wound around the least one teeth portion, and the least one first hole may be disposed in the least one teeth portion.

The teeth portion may be provided as a plurality of teeth portions, and the plurality of teeth portions may be disposed to be spaced apart from each other in a circumferential direction of the stator core. The least one first hole may include a plurality of first holes. The plurality of first holes may be disposed in the plurality of teeth portions, respectively.

The at second flow path may be disposed in a rotational axis direction of the rotor.

A bottom surface of the second flow path may be provided with a protrusion extending in the rotational axis direction.

The protrusion may be provided as a plurality of protrusions, and the plurality of protrusions may be disposed parallel to each other.

The second flow path may be provided as a plurality of second flow paths, and the plurality of second flow paths may be disposed to be spaced apart from each other in a circumferential direction of the stator core.

The third flow path may become narrower inward in the radial direction.

The third flow path may include a first portion, a second portion, a third portion, and a fourth portion, disposed from an outer side to an inner side in the radial direction. A width of the first portion may be constant, a width of the second portion may become narrower inward in the radial direction, a width of the third portion may become narrower inward in the radial direction, and a minimum width of the second portion may be greater than a minimum width of the third portion.

The second portion may include a first inclined surface having a constant inclination, and the third portion may include a second inclined surface having a constant inclination. The first inclined surface and the second inclined surface may form an obtuse angle.

A maximum width of the third flow path may be less than or equal to a width of the second flow path.

The third flow path may be provided as a plurality of third flow paths, and the plurality of third flow paths may be disposed to be spaced apart in a circumferential direction of the stator core.

The motor may include a housing with an internal space accommodating the stator, and the housing may include a supply hole which communicates with the first flow path and through which a cooling fluid is supplied.

According to an aspect of the present disclosure, a vehicle includes a motor as a power source. The motor includes a rotor; a stator core provided with the rotor disposed on an inside thereof; at least one teeth portion formed on an inner peripheral surface of the stator core; and a coil wound around the least one teeth portion. The least one teeth portion has at least one first hole facing the coil in a rotational axis direction of the rotor, an outer peripheral surface of the stator core includes a first flow path formed along a circumferential direction of the stator core, and the least one first hole communicates with the first flow path.

The stator core may have a second hole spaced apart from the first hole in a radial direction of the stator core, and the least one first hole and the second hole may communicate with each other.

The least one teeth portion may be provided as a plurality of teeth portions, and the plurality of teeth portions may be spaced apart from each other in the circumferential direction of the stator core. The least one first hole may be provided as a plurality of first holes, and the plurality of first holes may be disposed in the plurality of teeth portions, respectively.

In another embodiment, a motor includes: a stator; a coil wound around the stator core; and a rotor disposed inside the stator core. The stator core includes: a first flow path formed on an outer peripheral surface of the stator core along a circumferential direction of the stator core; second flow paths formed on the outer peripheral surface of the stator core, arranged along the circumferential direction and intersecting the first flow path; third flow paths disposed in a radial direction of the stator core and respectively communicating with the second flow paths; and a plurality of holes formed in the stator core and configured to respectively communicate with the third flow paths such that cooling fluid flows along the first flow path, the second flow paths, and the third flow paths and is injected toward the coil through the plurality of holes.

In an embodiment, the stator core further includes a plurality of teeth portions formed on an inner surface of stator core, and the coil is wound around the plurality of teeth portions, and the plurality of holes is respectively formed in the plurality of teeth portions.

In an embodiment, the cooling fluid having flowed along the first flow path flows in opposite directions along the second flow paths, and each teeth portion of the plurality of teeth portions includes at least two holes, among the plurality of holes, that are spaced apart from each other.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a cross-sectional view of a motor according to an embodiment;

FIG. 2 is a cross-sectional view of a cooling fluid sprayed at an area “A” in FIG. 1;

FIG. 3 is a perspective view of a stator core according to an embodiment.

FIG. 4 is a cross-sectional view of the I-I′ of the stator core in FIG. 3 according to an embodiment;

FIG. 5 is a front view of a stator core according to an embodiment;

FIG. 6 is a cross-sectional view taken along line II-II′ of FIG. 3, FIG. 7 is a cross-sectional view taken along line III-III′ of FIG. 3, FIG. 8 is a cross-sectional view taken along line IV-IV′ of FIG. 3, and FIG. 9 is a cross-sectional view taken along line V-V′ of FIG. 3;

FIG. 10 is a cross-sectional view of FIGS. 5 to 7 superimposed on each other; and

FIG. 11 is a side view of a stator core according to an embodiment.

### DETAILED DESCRIPTION

The present disclosure may have various modifications and various embodiments, and specific embodiments are illustrated in the drawings and described in detail. However, this is not intended to limit the present disclosure to specific embodiments, and it should be understood that all modifications, equivalents, and substitutes included in the spirit and technical scope of the present disclosure are included.

The terms such as first, second, etc. may be used to describe various components, but the components should not be limited by the terms. The terms are used only for the purpose of distinguishing one component from another. For example, without departing from the scope of the present disclosure, the first component may be named the second component, and similarly, the second component may also be named the first component. The term ‘and/or’ includes a combination of a plurality of related described items or any of a plurality of related described items.

The terms “-unit, -part, -portion, etc.” may be used to describe various components, but the components should not be limited by the terms. The above terms may refer to not only physically/visibly distinct configurations, but also to functions or configurations of corresponding parts even if the distinction/division is not clearly defined.

In the present disclosure, when a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function.

The terms used in this specification are used only to describe specific embodiments and are not intended to limit the present disclosure. The singular expression includes plural expressions unless the context clearly indicates otherwise. In this specification, the terms such as “include,” “have,” and the like should be understood to indicate the presence of features, numbers, steps, operations, components, parts, or combinations thereof described in the specification, but do not preclude the possibility of the presence or addition of one or more other features, numbers, steps, operations, components, parts, or combinations thereof.

Unless otherwise defined, all terms used herein, including technical or scientific terms, have the same meaning as generally understood by a person of ordinary skill in the art to which the present disclosure belongs. Terms that are defined in commonly used dictionaries should be interpreted as having a meaning consistent with the meaning they have in the context of the relevant technology, and are not interpreted in an ideal or overly formal sense unless explicitly defined in this specification.

In the present disclosure, vehicles refer to various vehicles that move a transported object such as a person, an animal, or an object from a starting point to a destination. Such vehicles are not limited to vehicles that run on roads or tracks. In addition, vehicles include those that use fossil fuels such as gasoline or petrol, as well as those that use secondary batteries that use electricity stored in batteries or the like, and those that use future fuels such as hydrogen.

In the description below, the terms “forward”, “backward”, “side”, “front”, “back”, “rear”, “upper”, “above”, “lower”, “below”, “left and right”, etc. used in relation to direction are defined based on the vehicle or body. In addition, the terms such as first, second, etc. may be used to describe various components, but these components are not limited in order, size, location, or importance by the terms of first, second, etc., and are named only for the purpose of distinguishing one component from another.

Hereinafter, with reference to the attached drawings, some embodiments are described in more detail.

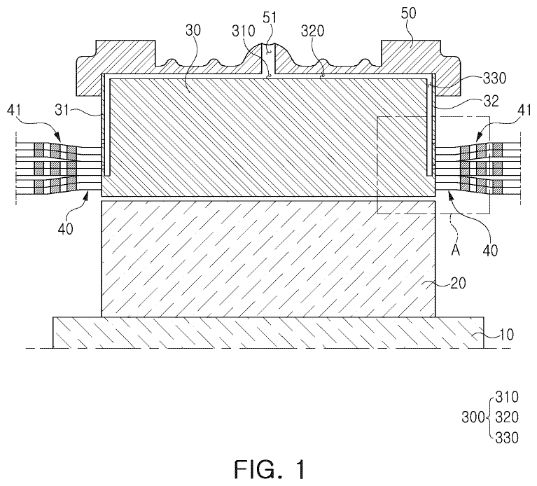

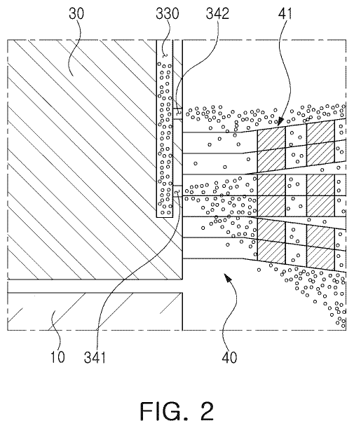

FIG. 1 illustrates a cross-section of a motor according to an embodiment, and FIG. 2 illustrates a cooling fluid being sprayed at an area “A” in FIG. 1. The structure of the motor in the present disclosure is described with reference to FIGS. 1 and 2.

A motor according to an embodiment may include a rotating shaft 10, a rotor core 20, a stator core 30, a coil 40, and a housing 50.

The rotating shaft 10 is coupled to the rotor core 20. The rotating shaft 10 is disposed at the center of rotation of the rotor core 20. The rotor core 20 is disposed rotatably inside the stator core 30. Although not illustrated in the drawing, a power transmission unit may be connected to one or the other side of the rotating shaft 10. The wheels of the vehicle may rotate through the power transmission unit. In detail, the motor may be used as a power source for the vehicle.

The stator core 30 has a hollow structure, and a rotor core 20 may be disposed inside the stator core 30. A gap is formed between the stator core 30 and the rotor core 20, and the stator core 30 and the rotor core 20 may not contact each other.

A coil 40 is wound around the stator core 30. When current flows through the coil 40, an electromagnetic force is generated, causing the rotor to rotate. An end portion 41 (or leg portion) of the coil 40 may protrude outward from the stator. In detail, the end portion 41 of the coil 40 may be disposed to protrude from the stator core 30 in the rotational axis direction.

A cooling path 300 is disposed in the stator core 30. A cooling fluid may flow through the cooling path 300. Oil may be used as the cooling fluid. The stator core 30 may include a first surface 31 that is disposed perpendicular to the rotational axis direction and a second surface 32 that is spaced apart from the first surface 31 in the rotational axis direction. Each of the first surface 31 and the second surface 32 may be disposed in a direction facing the end portion 41 of the coil 40.

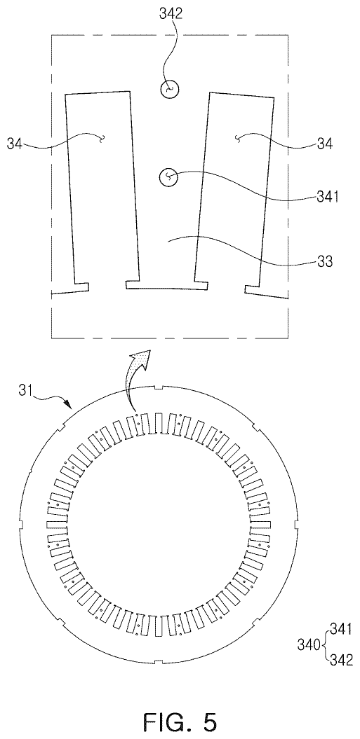

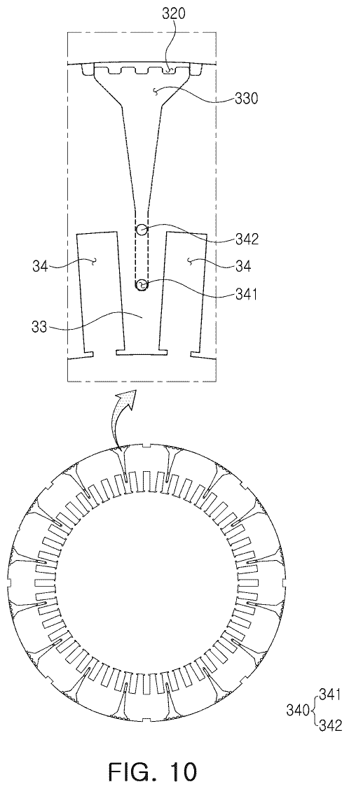

At least one hole 340 (in FIGS. 5 and 10) may be disposed in each of the first surface 31 and the second surface 32. A cooling fluid flowing through the cooling path 300 is sprayed through the at least one hole 340. Since the cooling fluid is sprayed to the end portion 41 of the coil 40 through the hole 340, the end portion 41 of the coil 40 may be cooled.

A housing 50 may be disposed on the outer side of the stator core 30. The housing 50 may be disposed to surround the stator core 30. A supply hole 51 communicating with the outside may be formed in the housing 50. Cooling fluid may be supplied through the supply hole 51. The cooling fluid supplied through the supply hole 51 may flow through the cooling path 300 of the stator core 30.

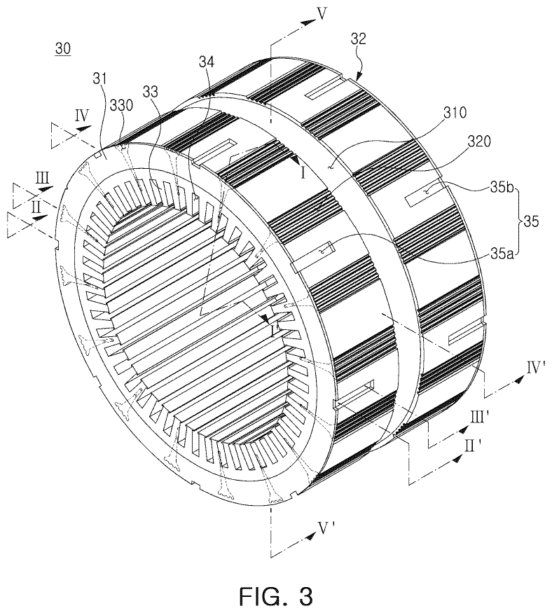

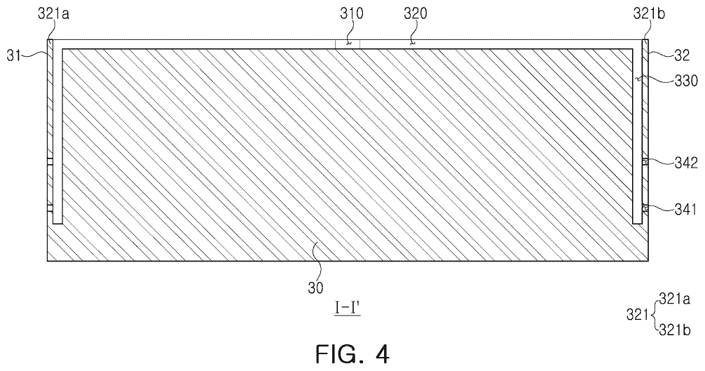

FIG. 3 is a perspective view of a stator core according to an embodiment, FIG. 4 is an I-I′ cross-section of the stator core, and FIG. 5 is a front view of the stator core. The structure of the stator core is described with reference to FIGS. 3 to 5.

The stator core 30 may have a cylindrical structure. A teeth portion 33 and a slot 34 are disposed on the inner peripheral surface of the stator core 30. The teeth portion 33 is provided in plural. A plurality of teeth portions 33 may be disposed to be spaced apart from each other in the circumferential direction along the inner peripheral surface of the stator core 30. A slot 34 is disposed between adjacent teeth portions 33. The coil 40 described above may be wound around the teeth portion 33. For example, the coil 40 may be disposed to surround the teeth portion 33, and at least a portion of the coil 40 may be disposed on the slot 34.

A key groove 35 may be formed in the outer peripheral surface of the stator core 30. The key groove 35 may be formed to extend in the rotational axis direction. For example, the length direction of the key groove 35 may be parallel to the rotational axis direction.

The key groove 35 may include a first key groove 35a and a second key groove 35b. The first key groove 35a and the second key groove 35b may be disposed to be spaced apart from each other in the rotational axis direction, with the first flow path 310 interposed therebetween.

The first key groove 35 and the second key groove 35 do not communicate with the first flow path 310. In addition, the length of the first key groove 35a and the second key groove 35b are each less than half (½) of the length of the stator core 30 in the rotational axis direction.

The first key groove 35a may be provided in multiple instances. A plurality of first key grooves 35a may be spaced apart from each other in the circumferential direction of the stator core 30.

A plurality of second key grooves 35b may be provided. The plurality of second key grooves 35b may be spaced apart from each other in the circumferential direction of the stator core 30.

The key groove 35 may serve to fix the stator core 30 to the housing 50. Although not illustrated in the drawing, one or more keys may be disposed in the key groove 35, and the key(s) may be coupled to the housing 50. Through this structure, the stator core 30 may be prevented from moving or rotating with respect to the housing 50.

The first flow path 310 may be formed in the outer peripheral surface of the stator core 30. The first flow path 310 may extend in the circumferential direction of the stator core 30. The first flow path 310 may be disposed at the center of the stator core 30 based on the rotational axis direction. The first flow path 310 may be disposed to communicate with the supply hole 51 of the housing. For example, a portion of the first flow path 310 may be disposed to directly face the supply hole 51 of the housing 50 in the radial direction of the stator core 30.

In an embodiment, a second flow path 320 may be formed in on the outer peripheral surface of the stator core 30. The second flow path 320 may be formed along the rotational axis direction which intersects the first flow path 310. The second flow path 320 may communicate with the first flow path 310.

In other words, the second flow path 320 may be formed to extend in the rotational axis direction. The second flow path 320 may be disposed parallel to the rotational axis direction. A step portion 321 may be disposed on the stator core 30. The step portion 321 may be disposed on both sides of the stator core 30.

For convenience of explanation, the step portion 321 on the left side of FIG. 4 is referred to as a first step portion 321a, and the step portion 321 on the right side is referred to as a second step portion 321b.

One end of the second flow path 320 may be extended to the first step portion 321a, and the other end of the second flow path 320 may be extended to the second step portion 321b. For example, the first step portion 321a and the second step portion 321b may prevent the cooling fluid flowing through the second flow path 320 from flowing to the outside of the stator core 30.

One end of the second flow path 320 may be in communication with the third flow path 330 disposed in one side of the stator core 30. The other end of the second flow path 320 may be in communication with the third flow path 330 disposed in the other side of the stator core 30. For example, the cooling fluid flowing through the second flow path 320 may flow to the third flow path 330.

The second flow path 320 may be disposed in multiples. The plurality of second flow paths 320 may be disposed to be spaced apart from each other in the circumferential direction of the stator core 30. The plurality of second flow paths 320 may be arranged in parallel.

The third flow path 330 may be disposed inside the stator core 30. For example, the third flow path 330 may have a structure in which a portion of the stator core 30 is introduced. The third flow path 330 may extend in the radial direction of the stator core 30.

The third flow path 330 may be disposed in multiples. The plurality of third flow paths 330 may be disposed to be spaced apart from each other in the circumferential direction of the stator core 30. The plurality of third flow paths 330 may be disposed radially around the rotational axis. For example, the plurality of third flow paths 330 may be positioned in a radial pattern around the rotational axis.

A hole 340 may be disposed in the first surface 31 and the second surface 32 of the stator core 30. Since the first surface 31 and the second surface 32 of the stator core 30 may have the same shape, the description of the structure of the second surface 32 is replaced with the description of the structure of the first surface 31. Referring to FIG. 3 and FIG. 5, the hole 340 may be formed in the first surface 31, which is the front surface of the stator core 30. The hole 340 may include a first hole 341 and a second hole 342.

The first hole 341 may be disposed in the teeth portion 33 of the stator core 30. The first hole 341 may be in communication with the third flow path 330. The cooling fluid flowing through the third flow path 330 may be sprayed from the stator core 30 toward the coil through the first hole 341.

The first hole 341 may be disposed in multiple numbers. The plurality of first holes 341 may be disposed in the plurality of teeth portions 33, respectively. Therefore, the plurality of first holes 341 may be disposed to be spaced apart from each other in the circumferential direction of the stator core 30.

The second hole 342 may be disposed to be spaced apart from the first hole 341 in the radial direction of the stator core 30. The second hole 342 may be in communication with the third flow path 330. The cooling fluid flowing through the third flow path 330 may be sprayed from the stator core 30 toward the coil through the second hole 342.

The second hole 342 may be disposed in multiple numbers. A plurality of second holes 342 may be disposed to be spaced apart along the circumference of the stator core 30.

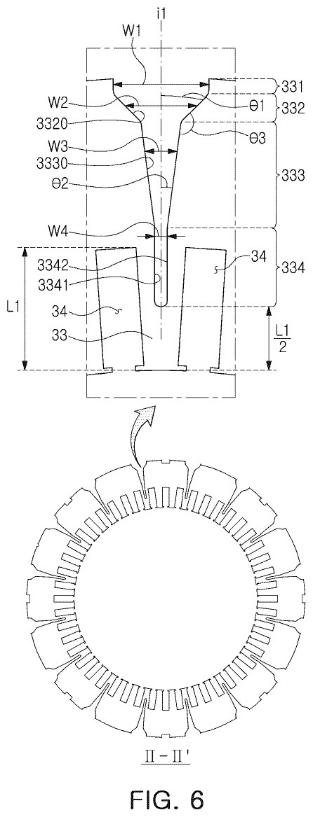

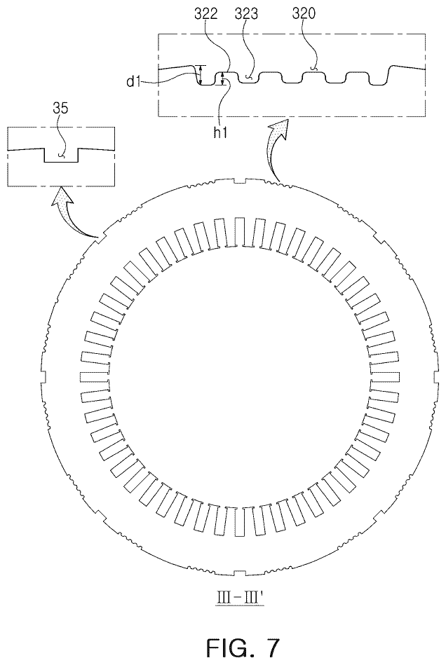

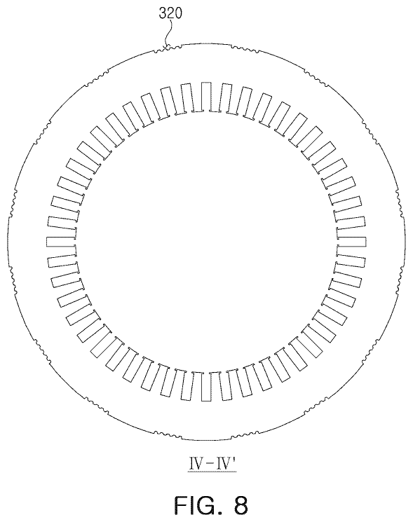

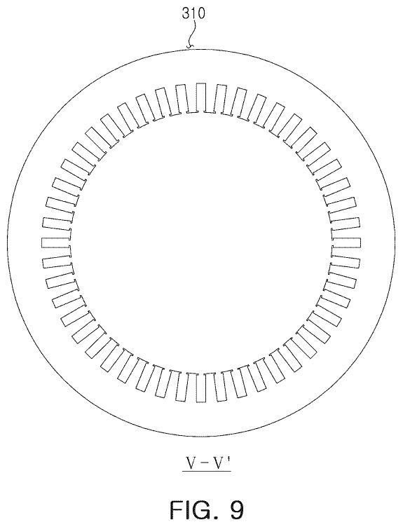

FIG. 6 is a cross-section of II-II′ of FIG. 3, FIG. 7 is a cross-section of III-III′ of FIG. 3, FIG. 8 is a cross-section of IV-IV′ of FIG. 3, and FIG. 9 is a cross-section of V-V′ of FIG. 3. The structure of the stator core will be examined in more detail with reference to FIGS. 6 to 9.

Referring to FIG. 6, the third flow path may have a narrower width in the radial direction than the width in the radial direction on the inner side of the stator core 30.

In detail, the third flow path 330 may include a first portion 331, a second portion 332, a third portion 333, and a fourth portion 334. In this case, the first portion 331 to the fourth portion 334 may be sequentially disposed from the outer side to the inner side of the stator core 30 in the radial direction.

The first portion 331 may be disposed at the outermost side of the stator core 30 in the radial direction. The width W1 of the first portion is constant in the radial direction of the stator core 30.

The second portion 332 may be disposed in connection with the first portion 331. The width W2 of the second portion may become narrower as it goes inward in the radial direction of the stator core 30. The maximum width W2 of the second portion may be equal to the maximum width W1 of the first portion, and the minimum width W2 of the second portion may be smaller than the maximum width W1 of the first portion.

The second portion 332 may include an inclined surface. The inclined surface of the second portion 332 may be referred to as the first inclined surface 3320. The inclination of the first inclined surface 3320 may be constant. The first inclined surface 3320 may form an acute angle based on a virtual line “i1” disposed at the center of the width direction of the second portion 332. The acute angle formed by the first inclined surface may be referred to as the first acute angle “θ1”.

The third portion 333 may be disposed to be connected to the second portion 332. The width W3 of the third portion may become narrower as it goes radially inward of the stator core 30. The maximum width W3 of the third portion may be equal to the minimum width W2 of the second portion, and the minimum width W3 of the third portion may be smaller than the minimum width W2 of the second portion. In addition, the minimum width W2 of the second portion may be larger than the minimum width W3 of the third portion.

The third portion 333 may include an inclined surface. The inclined surface of the third portion 333 may be referred to as the second inclined surface 3330. The inclination of the second inclined surface 3330 may be constant. Based on the virtual line “i1” disposed at the center of the width direction of the third portion 333, the second inclined surface 3330 may form an acute angle. The acute angle formed by the second inclined surface 3330 may be referred to as a second acute angle “θ2”.

The first acute angle “θ1” formed by the first inclined surface 3320 and the second acute angle “θ2” formed by the second inclined surface 3330 are different. In detail, the first acute angle θ1 may be formed larger than the second acute angle θ2. In addition, the first inclined surface 3320 and the second inclined surface 3330 may form an obtuse angle “θ3”.

The width of the third flow path 330 is gradually reduced in the second portion 332 and the third portion 333. The width W2 of the second portion is uniformly reduced toward the center of the stator core 30, and the width W3 of the third portion is uniformly reduced toward the center of the stator core 30. Through this structure, the flow resistance of the cooling fluid flowing through the third flow path 330 may be significantly reduced. In addition, since the width W3 of the third flow path is reduced toward the center of the stator core 30, the flow velocity of the fluid flowing through the third flow path 330 may increase.

The fourth portion 334 may be disposed to be connected to the third portion 333. The fourth portion 334 may include a first side surface 3341 and a second side surface 3342 that are disposed parallel to each other and face each other. The ends of the first side surface 3341 and the second side surface 3342 may be connected to a curved surface. The width W4 of the fourth portion based on the first side surface 3341 and the second side surface 3342 may be equal to the minimum width W3 of the third portion.

The width W4 of the fourth portion may be constant. The width W4 of the fourth portion may be equal to the minimum width W3 of the third portion. The first side surface 3341 and the second side surface 3342 of the fourth portion 334 may be disposed parallel to an imaginary line i1. Based on the radial direction of the stator core 30, the fourth portion 334 may be extended to a position of ½ of the length L1 of the teeth portion.

Referring to FIG. 7, a second flow path 320 and a key groove 35 may be disposed on the outer peripheral surface of the stator core 30. The second flow path 320 may be disposed on both sides of the key groove 35. The width W5 of the key groove 35 may be smaller than the width of the second flow path 320. An uneven structure may be disposed on the bottom surface of the second flow path 320. For example, a protrusion 322 and a groove portion 323 may be repeatedly disposed on the bottom surface of the second flow path 320.

When the length from the outer peripheral surface of the stator core 30 to the bottom surface of the groove portion 323 is referred to as the depth d1 of the second flow path, and the length from the bottom surface of the groove portion 323 to the end of the protrusion 322 is referred to as the height h1 of the protrusion, the height h1 of the protrusion may be smaller than the depth d1 of the second flow path.

Referring to FIG. 8, a second flow path may be disposed on the outer peripheral surface of the stator core. The specific structure of the second flow path is as described in FIG. 7.

Referring to FIG. 9, the outer peripheral surface of the stator core 30 may be the first flow path 310. The first flow path 310 may extend along the outer peripheral surface of the stator core 30. In order for the first flow path 310 to be formed, the maximum diameter of the stator core 30 based on FIG. 9 may be smaller than the maximum diameter of the stator core 30 based on FIGS. 6 to 8.

FIG. 10 is a drawing of FIGS. 5 to 7 superimposed. Referring to FIG. 10, the first hole 341 overlaps the fourth portion 334 of the third flow path 330 in the rotational axis direction, and all or part of the second hole 342 overlaps the fourth portion 334 of the third flow path 330 in the rotational axis direction. The first portion 331 of the third flow path 330 overlaps the second flow path 320 in the rotational axis direction, and the width of the first portion 331 is formed narrower than the width of the second flow path 320.

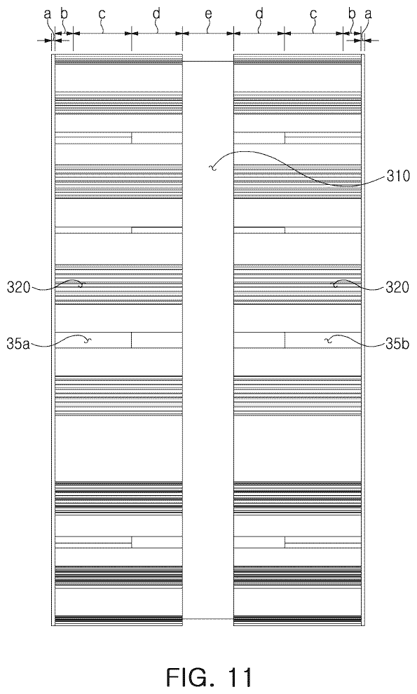

FIG. 11 is a side view of a stator core according to an embodiment. Referring to FIGS. 5 to 9 and FIG. 11, a method of forming a stator core according to an embodiment will be described.

A stator core 30 according to an embodiment may be formed by stacking a plurality of sheets. A stator core according to an embodiment may be composed of first to fifth sheets, and each of the first to fifth sheets may be provided in plurality that are stacked.

Referring to FIGS. 5 to 8, FIG. 5 illustrates a shape of the first sheet as seen from the front, FIG. 6 illustrates a shape of the second sheet as seen from the front, FIG. 7 illustrates a shape of the third sheet as seen from the front, and FIG. 8 illustrates a shape of the fourth sheet as seen from the front.

Referring to FIG. 11, a stator core 30 according to an embodiment may be divided into sections a, b, c, d, and e. Since sections a, b, c, and d are respectively disposed before and after section e, the stator core 30 may have a symmetrical structure centered on section e.

Section “a” is a section where multiple first sheets are stacked, section “b” is a section where multiple second sheets are stacked, section “c” is a section where multiple third sheets are stacked, section “d” is a section where multiple fourth sheets are stacked, and section “e” is a section where multiple fifth sheets are stacked.

The first to fifth sheets have different front structures. The first flow path, the second flow path, and the third flow path of the stator core may be formed by stacking the first to fifth sheets having different front structures.

Referring to FIG. 1, FIG. 2, and FIG. 10, the cooling fluid introduced through the supply hole 51 may move to the third flow path 330 through the first flow path 310 and the second flow path 320. The third flow path 330 includes a structure in which the width gradually narrows, so that the flow rate of the cooling fluid may gradually increase. This increase in the flow rate may cause the fluid to be strongly sprayed outside the stator core 30 through the first hole 341 and the second hole 342.

The sprayed cooling fluid may efficiently cool the coil 40 by contacting the coil end portion 41. Accordingly, the temperature of the coil 40 may be maintained at an appropriate level, and performance degradation or damage to the motor due to overheating may be prevented.

As set forth above, a motor according to an embodiment has an effect of effectively cooling a stator of the motor, thereby preventing a decrease in performance of the motor or damage to the motor.

While example embodiments have been illustrated and described above, it should be apparent to those having ordinary skill in the art that modifications and variations could be made without departing from the scope of the present disclosure as defined by the appended claims.

What is claimed is:

1. A motor comprising:
a stator core; and
a rotor disposed inside the stator core,
wherein the stator core includes,
a first flow path disposed along an outer peripheral surface of the stator core;
at least one second flow path intersecting the first flow path;
at least one third flow path communicating with the at least one second flow path and disposed in a radial direction of the stator core; and
at least one hole formed in a front surface of the stator core and configured to communicate with the third flow path.

2. The motor of claim 1, wherein the at least one hole includes a plurality of holes,
wherein the plurality of holes include,
a first hole; and
a second hole spaced apart from the first hole radially outwardly of the stator core.

3. The motor of claim 1, wherein the stator core includes at least one teeth portion formed on an inner surface of the stator core, and a coil is wound around the at least one teeth portion, and
the at least one hole is disposed in the at least one teeth portion.

4. The motor of claim 3, wherein the at least one teeth portion includes a plurality of teeth portions,
wherein teeth portions of the plurality of teeth portions are spaced apart from each other in a circumferential direction of the stator core, and
the at least one hole is disposed in each of the teeth portions.

5. The motor of claim 1, wherein the at least one second flow path is disposed in a rotational axis direction of the rotor.

6. The motor of claim 5, wherein a bottom surface of the at least one second flow path includes at least one protrusion extending in the rotational axis direction.

7. The motor of claim 6, wherein the at least one protrusion includes a plurality of protrusions,
wherein protrusions of the plurality of protrusions are disposed parallel to each other.

8. The motor of claim 6, wherein the at least one second flow path includes a plurality of second flow paths,
wherein second flow paths of the plurality of second flow paths are spaced apart from each other in a circumferential direction of the stator core.

9. The motor of claim 1, wherein the at least one third flow path becomes narrower inward in the radial direction.

10. The motor of claim 9, wherein the at least one third flow path includes a first portion, a second portion, a third portion, and a fourth portion, disposed from an outer side to an inner side in the radial direction,
wherein:
a width of the first portion is constant,
a width of the second portion becomes narrower inward in the radial direction,
a width of the third portion becomes narrower inward in the radial direction, and
a minimum width of the second portion is greater than a minimum width of the third portion.

11. The motor of claim 10, wherein the second portion includes a first inclined surface having a constant inclination, and
the third portion includes a second inclined surface having a constant inclination,
wherein the first inclined surface and the second inclined surface form an obtuse angle.

12. The motor of claim 9, wherein a maximum width of the at least one third flow path is less than or equal to a width of the second flow path.

13. The motor of claim 9, wherein the at least one third flow path includes a plurality of third flow paths,
wherein third flow paths of the plurality of third flow paths are spaced apart in a circumferential direction of the stator core.

14. The motor of claim 1, comprising: a housing with an internal space accommodating the stator core,
wherein the housing includes a supply hole which communicates with the first flow path and through which a cooling fluid is supplied.

15. A vehicle comprising:
a motor as a power source,
wherein the motor includes,
a stator core;
a rotor arranged within the stator core;
at least one teeth portion formed on an inner peripheral surface of the stator core; and
a coil wound around the at least one teeth portion,
wherein:
the at least one teeth portion includes at least one first hole facing the coil in a rotational axis direction of the rotor,
an outer peripheral surface of the stator includes a first flow path formed along a circumferential direction of the stator core, and
the at least one first hole communicates with the first flow path.

16. The vehicle of claim 15, wherein the stator core includes a second hole spaced apart from the at least one first hole in a radial direction of the stator core, and
the at least one first hole and the second hole communicate with each other.

17. The vehicle of claim 16, wherein the at least one teeth portion includes a plurality of teeth portions,
wherein teeth portions of the plurality of teeth portions are spaced apart from each other in the circumferential direction of the stator core, and
wherein the at least one first hole includes a plurality of first holes, and
wherein first holes of the plurality of first holes are disposed in teeth portions of the plurality of teeth portions, respectively.

18. A motor comprising:
a stator core;
a coil wound around the stator core; and
a rotor disposed inside the stator core,
wherein the stator core includes,
a first flow path formed on an outer peripheral surface of the stator core along a circumferential direction of the stator core;
second flow paths formed on the outer peripheral surface of the stator core, arranged along the circumferential direction and intersecting the first flow path;
third flow paths disposed in a radial direction of the stator core and respectively communicating with the second flow paths; and
a plurality of holes formed in the stator core and configured to respectively communicate with the third flow paths such that cooling fluid flows along the first flow path, the second flow paths, and the third flow paths and is injected toward the coil through the plurality of holes.

19. The motor of claim 18, wherein the stator core includes a plurality of teeth portions formed on an inner surface of stator core, and the coil is wound around the plurality of teeth portions, and
the plurality of holes is respectively formed in the plurality of teeth portions.

20. The motor of claim 19, wherein the cooling fluid having flowed along the first flow path flows in opposite directions along the second flow paths, and
each teeth portion of the plurality of teeth portions includes at least two holes, among the plurality of holes, that are spaced apart from each other.
